(19) United States
(12) Patent Application Publication
(10) Pub. No.: US 2010/0098301 A1
(43) Pub. Date: Apr. 22, 2010

(54) Method and Device for Recognizing a Face and Face Recognition Module

(76) Inventor: Xuebing Zhou, Darmstadt (DE)

Correspondence Address: LERNER GREENBERG STEMER LLP, P O BOX 2480, HOLLYWOOD, FL, 33022-2480, US

(21) Appl. No.: 12/442,444

(22) PCT Filed: Sep. 21, 2007
(86) PCT No.: PCT/EP07/08507

§ 371 Date: Mar. 23, 2009

(30) Foreign Application Priority Data
Sep. 22, 2006 (DE) 10 2006 045 828.1

(51) Int. Cl. G06K 9/00

(52) U.S. Cl. 382/118; 348/46; 382/154

(57) ABSTRACT

A method, device and module for recognizing a face are provided. A 3D-recognition unit recognizes three-dimensional face information in the form of a face information data set. The detected face information includes location information of surface contours of the face. A position normalization step and an orientation normalization step are performed. A feature data set, which is derived from the normalized detected face information, is compared with at least one previously known feature data set of a previously known face. The face is recognized as a previously known face if one or more predefined comparison criteria are fulfilled. The location information encompasses contour coordinates and a frequency distribution is determined in evaluation regions. The frequency distribution indicates how many contour coordinates are located within the individual evaluation regions. The feature data set is derived from the determined frequency.

The invention relates to a method and an apparatus for recognizing a face and to a face recognition module which can be used to recognize a face.

The prior art discloses various methods which allow only unsatisfactory face recognition. In principle, a distinction is drawn between methods which use two-dimensional data, for example with images taken using a camera, and methods which evaluate three-dimensional data for the face. Fundamental problems in the methods using two-dimensional data have been solved only unsatisfactorily to date. These problems include various disturbing factors, for example, a change in the pose of the face and a variation in the facial expression, which make it difficult to recognize a face. A pose is understood to mean a change in the posture of the head relative to the data recording unit. If the head is rotated about a vertical axis (i.e. about the spinal axis), for example, portions of the 2D face information are irrevocably lost in this case. Methods which evaluate three-dimensional data are therefore better suited to achieving a high level of recognition reliability.

The starting point used for methods which evaluate three-dimensional data is raw data, which are picked up by what is known as the 3D recording unit. The 3D recording units record face information, which comprises location information relating to surface contours of the face. Common 3D recording units today use either fringe projection methods or use stereoscopic pictures of the face. A fringe projection method, which is also referred to as an active method, involves projection of fringe patterns onto the face and analysis of distortion in the fringes. As in the case of methods which use stereoscopic pictures, the location information (i.e. the coordinates of a point on a surface contour of the face) is determined using a triangulation method. A face information data record can be represented in different ways. It is either possible to represent the face as what is known as a 3D space model, by storing the data as three-dimensional coordinates, or alternatively, for each contour coordinate point, i.e. each point on the surface of the face, for which coordinates have been recorded using the 3D recording unit, it is possible to show a piece of depth information from a projection plane coupled to a projection point into the plane. In such a case, the depth information (distance information from the projection plane) can be encoded as a grayscale value, for example. Both forms of presentation can be converted to one another if there are no surface contours which conceal surface structures that are more remote from the detection plane when the face is viewed from the projection plane. In the case of 3D recording units in which the recording takes place essentially in a detection plane which is used as a projection plane, this assumption is normally met.

The prior art discloses various methods which are used for recognizing faces. One method uses what are known as eigenfaces. This method is described in K. Chang et al. “Multi-Modal 2D and 3D Biometrics for Face Recognition”, Proceedings of the IEEE International Workshop on Analysis and Modeling of Faces and Gestures (AMFG'03), Nice, France, October 2003, pages 187 to 194, for example. A sum total of faces provided for the recognition is used to calculate a number of eigenfaces, which give prominence to characteristic features of the faces in the sum total of the faces to be recognized. The eigenfaces are considered as a basis for a subspace for the face data. The individual faces are broken down in respect of these eigenvectors, and the breakdown coefficients ascertained in this context are stored as a feature data record, for example in the form of a feature vector. During what is known as a training face, all images of the set of the faces to be recognized are therefore used for ascertaining the eigenfaces and subsequently calculating the feature vectors, which are then stored in a database. When a face to be recognized is analyzed, the relevant feature vector is first of all ascertained for it and is then compared with the feature vectors stored in the database for the faces from the set of known faces and faces which are provided for recognition. A face is recognized as a known face if particular comparison criteria are met. In this case, it is possible to apply various comparison methods, for example a maximum likelihood method.

A further method in the prior art uses what are known as fisherfaces. In this case, each face in the set of faces provided for recognition requires a plurality of face information data records. The fisherfaces are ascertained using all the known face data records such that the coefficients of different faces differ greatly from one another, whereas the coefficients of the plurality of face information data records for the same face preferably have a minimal discrepancy.

The two known methods have the crucial drawback that the eigenfaces and fisherfaces each need to be redetermined when a further face is added to the set of faces to be recognized. The computation involvement required for this increases greatly as the number of faces provided for recognition increases. In addition, this always involves resorting to the complete face information data records (3D data records) for the faces, which therefore all need to be stored.

The invention is therefore based on the technical object of providing an improved method, an improved apparatus and a face recognition module which can be executed on a computer which allow reliable face recognition but significantly reduce a computation involvement, particularly when new faces are added to a set of faces to be recognized, in comparison with the known methods.

The invention achieves the technical object by means of a method having the features of patent claim 1, an apparatus having the features of patent claim 11 and a face recognition module having the features of patent claim 21. The invention is based on the insight that contour coordinate points for a face can respectively be combined into three-dimensional evaluation areas. For the individual evaluation areas, what are known as frequencies are obtained which indicate how many contour coordinate points are in the respective evaluation area. A frequency distribution obtained in this manner for the evaluation areas is characteristic of a face.

In particular, a method for recognizing a face is therefore proposed, comprising:
recording of three-dimensional face information for a face using a 3D recording unit in the form of a face information data record,
wherein the recorded face information comprises location information relating to surface contours of the face,
normalization of the recorded face information, wherein position normalization and orientation normalization for the face represented by the face information are performed, and
comparison of a feature data record, derived from the normalized recorded face information, with at least one previously known feature data record for a previously known face, wherein the face is recognized as the previously known face if one or more prescribed comparison criteria are met, wherein the invention provides for the location information to comprise contour coordinate points, and for evaluation areas to have a frequency distribution ascertained for them which indicates how many contour coordinate points are in the individual evaluation areas, and for the feature data record to be derived from the ascertained frequencies.

Normalization of the recorded face information is necessary in order to be able to compare different faces with one another. This involves the performance of position normalization. This ensures that a characteristic point which is present in all faces, for example the tip of a nose, is in each case at a previously stipulated position, for example is at a defined distance perpendicularly from a marked point in a detection plane. Orientation normalization ensures that an orientation for the face in three-dimensional space matches a prescribed orientation as closely as possible. This can be done by ascertaining further characteristic points of the face, for example the bridge of a nose or the positions of the eyes, and correcting the face information such that a connecting line between the tip of the nose and the bridge of the nose coincides with a coordinate axis in a three-dimensional coordinate system when projected perpendicularly onto the detection plane, the coordinate axis being in the detection plane. A third characteristic point is used to align the orientation of the face represented by the normalized face information with a prescribed orientation. Normalization methods reduce the influences of poses and are known to a person skilled in the art and not explained in more detail at this juncture. The indicated method is mentioned merely by way of example. Any normalization method can be used, provided that the face information afterwards is such that it represents a face matching a prescribed orientation at a stipulated location, preferably a face oriented at the front of the detection plane at a stipulated distance vertically above a marked point on the detection plane.

An apparatus according to the invention for recognizing a human face comprises a recording unit for recording three-dimensional face information for a face in the form of a face information data record, wherein the recorded face information comprises location information relating to surface contours of the face, a normalization unit for normalizing the recorded face information, wherein the normalization comprises position normalization and orientation normalization, and a comparison unit for comparing a feature data record, derived from the normalized recorded face information, with at least one previously known feature data record for a previously known face, wherein the face is recognized as the previously known face if one or more prescribed comparison criteria are met, wherein the location information comprises contour coordinate points, and an evaluation unit is provided for the purpose of ascertaining a frequency distribution for evaluation areas, the frequency distribution indicating how many contour coordinate points are in the individual evaluation areas, and for the purpose of deriving the feature data record from the ascertained frequencies. The normalization is today frequently performed in the actual 3D recording units. An inventive computer-executable face recognition module for recognizing a face therefore comprises an interface for receiving recorded three-dimensional face information for a face in the form of a face information data record, wherein the recorded face information comprises location information relating to surface contours of the face, a comparison unit for comparing a feature data record, derived from the recorded face information, with at least one previously known feature data record for a previously known face, wherein the face is recognized as a previously known face if one or more prescribed comparison criteria are met, wherein the location information comprises contour coordinate points, and an evaluation unit is provided for the purpose of ascertaining a frequency distribution for evaluation areas, the frequency distribution indicating how many contour coordinate points are in the individual evaluation areas, and for the purpose of deriving the feature data record from the ascertained frequencies. The feature data record can be compared with a previously known feature data record using any desired method for ascertaining a similarity for feature data records which is known in the prior art. Feature data records are preferably represented as feature vectors. The similarity can be determined using what is known as a city block method, for example, or by evaluating a euclidian distance, to mention but a few methods by way of example.

The great advantage of the invention is that only one feature data record needs to be ascertained in order to add the face to a set of faces to be recognized. It is not necessary to resort to all feature data records stored in a database or even to entire face information data records. This significantly reduces the total volume of data to be stored, since it is not necessary to store the complete face information for any of the faces over a long period. In addition, the method is very stable in the face of measurement errors known as outliers. Such outliers are considered to refer to recorded contour coordinate points for which a coordinate value differs very greatly from the coordinate values which have contour coordinate points which can be considered to be adjacent contour coordinate points in relation to the other two coordinate values. This means that in a grayscale representation of the contour coordinate points, the contour coordinate point whose grayscale value differs greatly from the grayscale values of the surrounding points is an outlier.

In one particularly preferred embodiment of the evaluation areas, they comprise at least one set of subareas which differ from one another only in respect of a depth range covered by them. In this context, the subareas may be identical to the evaluation areas. The depth information is respectively based on a detection plane which is used as a reference plane. Any desired other reference plane parallel to the detection plane can likewise be used. It has been found that the classification of the contour coordinate points into depth classes is characteristic of each face. If the face is represented by means of a grayscale representation, for example, grayscale ranges are stipulated. For the individual grayscale value ranges, the number of times they occur in a representation of a face is ascertained. The frequencies with which the individual grayscale ranges occur are characteristic of a respective face. To compare this face with a previously known face, it is therefore merely necessary, in principle, to compare these frequencies with one another.

Since the individual faces which need to be compared with one another in order to recognize a face do not all have the same physical extent, one preferred embodiment of the invention has provision for the evaluation areas to be in an evaluation space which comprises only a subregion of a mapping space which may contain recorded contour coordinate points. Overall, the evaluation areas in this embodiment are stipulated such that they are all in an evaluation space which is a subspace of the mapping space which comprises the set of all the coordinate points in which it would be possible to record contour coordinate points for a face.

The frequencies which are ascertained for the individual evaluation areas have the greatest differences if the individual evaluation areas are disjunct from one another.

By contrast, other embodiments may provide for the evaluation areas not to be disjunct. For a grayscale representation in which the evaluation areas differ merely in respect of their depth information, this means that individual grayscale values could be associated with a plurality of grayscale ranges. As a result, it is possible to relate a total number of contour coordinate points in a particular depth range to a depth range covered thereby. This means that individual face features which are in a particular depth range can be worked out particularly distinctly.

To be able to determine the evaluation space in optimum fashion, one preferred embodiment of the invention has provision for a set of training faces to have training face information data records recorded for it, for the face information contained therein to be normalized and for the evaluation space to be stipulated using the training face information data records such that the evaluation space contains, for each of the training face information data records, at least a respective stipulated percentage of the contour coordinate points which can be associated with the relevant training face. This means that the evaluation space is stipulated such that, for all the training face information data records within the three-dimensional evaluation space, at least a stipulated percentage of contour coordinate points are present which represent the contours of the training face, and hence only a residual portion (defined by means of the percentage) of contour coordinate points which represent other objects which have been recorded as “disturbance” is present. In this context, firstly a two-dimensional extent parallel to a detection plane is considered and secondly a depth extent for the face information relative to the detection plane. This information is used to stipulate the evaluation space. This allows an evaluation space to be stipulated in optimum fashion in this embodiment using a small set of training faces.

In one preferred development of the invention, the evaluation areas are stipulated such that the feature data records for the individual training faces differ from one another to the maximum extent. This embodiment affords the advantage that a small number of training faces can again be used to stipulate the evaluation areas in an optimum fashion in order to obtain feature data records which are as different as possible from the individual faces. In this context, the evaluation areas do not need to fill the entire evaluation space completely. Rather, individual space ranges which are considered unmeaningful can be ignored for an evaluation. In addition, the evaluation areas may comprise two or more sets of subareas which differ from one another within a set only in respect of a respective depth range covered by them.

In one preferred embodiment of the invention, the at least one previously known feature data record is ascertained using the method as described above and is stored in a data store, the method step of comparison being able to be omitted, i.e. is normally not performed. If a comparison is made while a new face is recorded, this makes it possible to find out whether the face has a high level of similarity with an already recorded face or whether the face has even been recorded in duplicate.

To allow a face to be identified with a person, one preferred embodiment has provision for the at least one previously known feature data record to be stored with identification information for the previously known face in a database in the data store.

An enormous advantage of the method is that a set of the training faces is chosen as a genuine subset of the faces to be recognized or is even chosen disjunctly from the set of the faces to be recognized. As already mentioned above, this drastically reduces computation complexity in comparison with the methods known from the prior art.

The corresponding features of the apparatus according to the invention and of the face recognition module according to the invention have the same advantages as the corresponding features of the method according to the invention.

The invention is explained in more detail below using a preferred exemplary embodiment with reference to a drawing, in which:

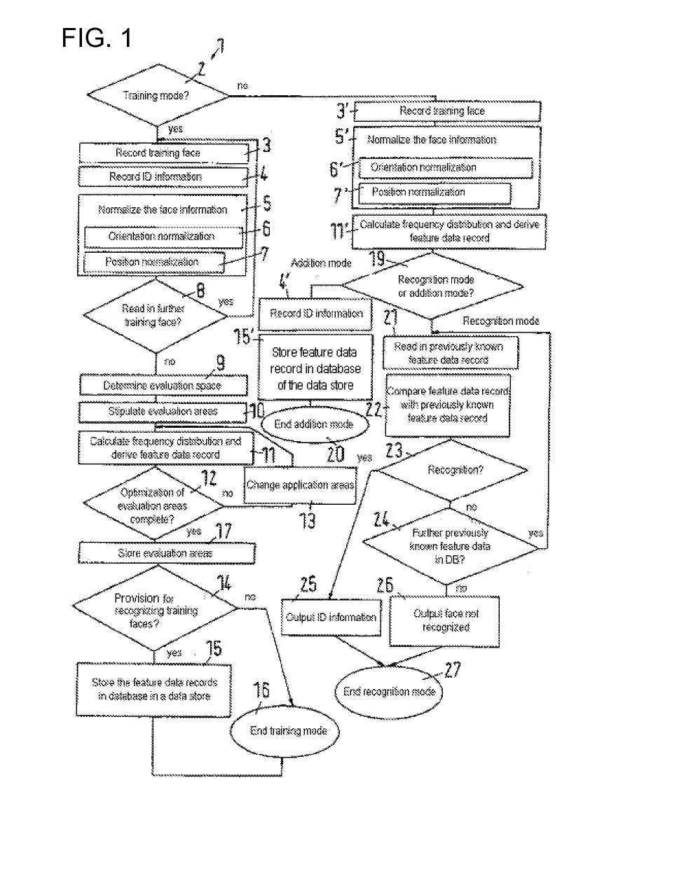

FIG. 1 shows a flowchart of an embodiment of a method for recognizing a face;

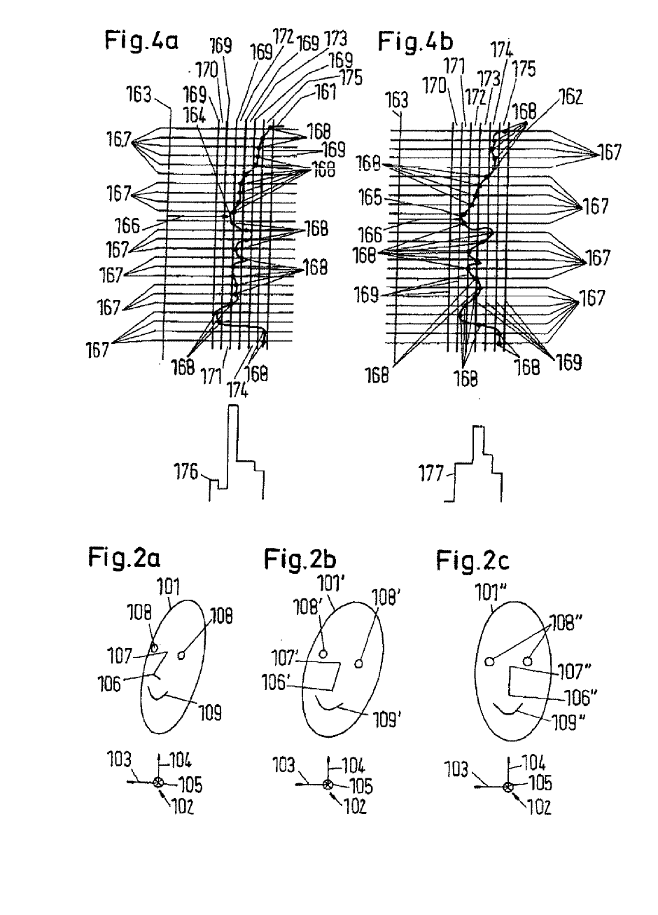

FIGS. 2a-2c show schematic illustrations of recorded face information for illustrating orientation normalization;

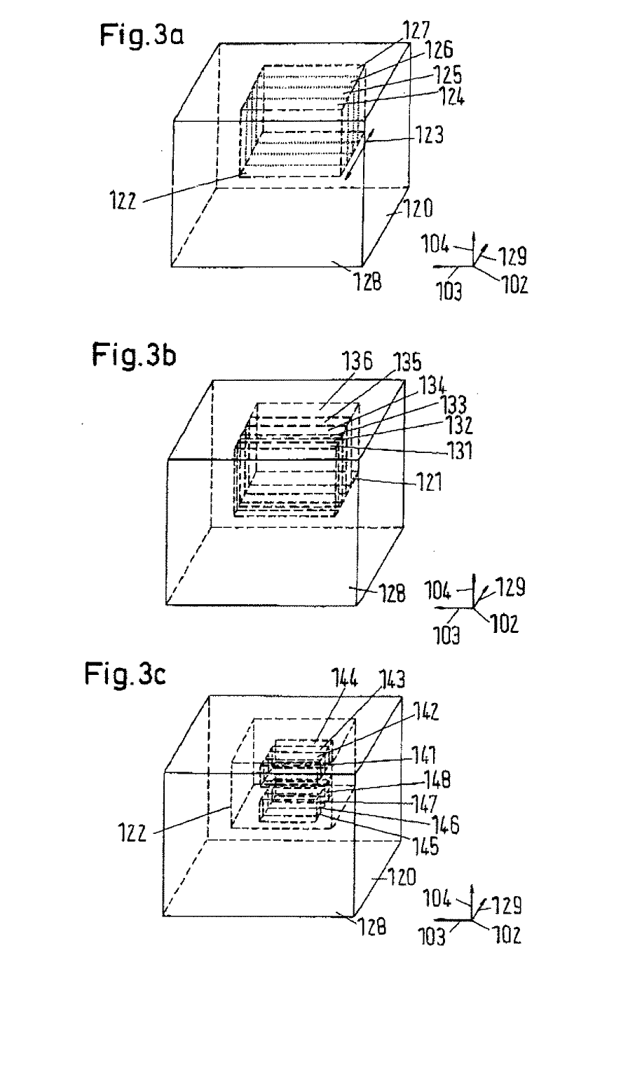

FIGS. 3a-3c show schematic illustrations of a mapping space in which an evaluation space is divided differently into evaluation areas;

FIGS. 4a, 4b show two sectional illustrations through schematic faces perpendicular to a detection plane to illustrate the association between contour coordinate points and individual evaluation areas for ascertaining the frequency distributions of the contour coordinate points in relation to the evaluation areas;

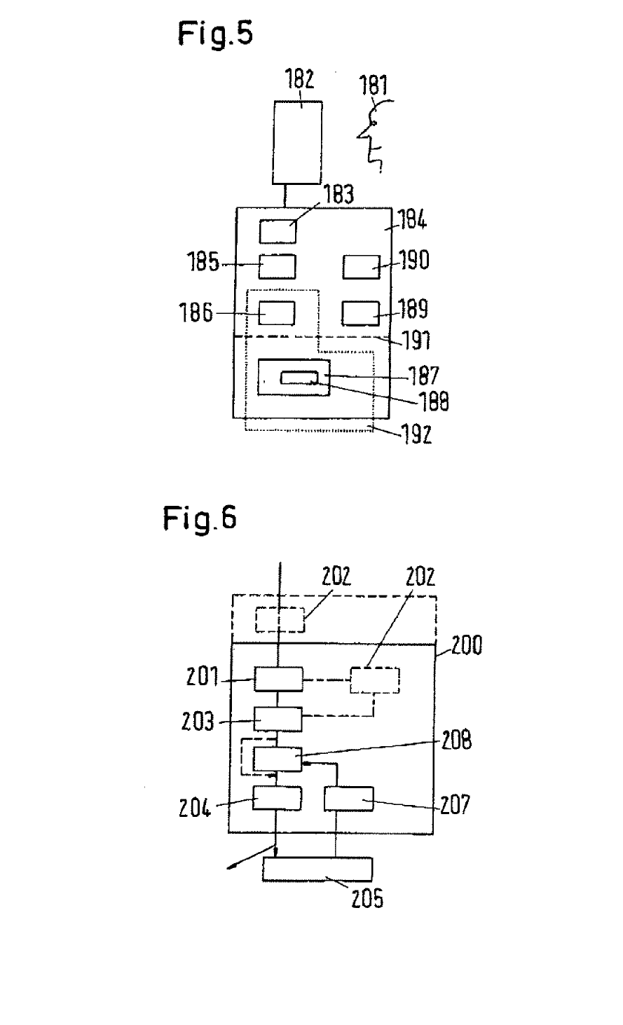

FIG. 5 shows a schematic illustration of an apparatus for a face recognition; and

FIG. 6 shows a schematic illustration of a face recognition module.

FIG. 1 will be used to explain a schematic sequence of a method 1 for recognizing a face. The method can be operated in three different modes. These three modes comprise a training mode, a recognition mode and an addition mode. First of all, a test is performed to determine whether the method is to be carried out in the training mode 2. If this is the case, face information for a training face is recorded using a 3D recording unit. The face information comprises location information relating to contours of the face. The face information is recorded in the form of a training face information data record. If appropriate, a further step is used to record identification information relating to the training face 4. The recorded face information is then normalized 5. The training face information data record may be shown represented in the form of space coordinates, i.e. a three-dimensional face model, or in the form of a grayscale representation plotted over a surface, in which the grayscales represent coefficients for a third coordinate axis. Normalization can be effected both in the three-dimensional face model and in the grayscale representation.

FIG. 2a schematically shows a recorded face 101. A detection plane is oriented parallel to a plane of the drawing. A right-handed coordinate system 102 is shown below the recorded face 101. An x-axis 103 and a y-axis 104 are in the plane of the drawing. A z-axis extends perpendicularly into the mapping plane, which is shown by means of a cross 5. With reference to the detection plane, the face is both rotated about the y-axis and inclined with respect to the y-axis.

Methods known in the prior art are used to ascertain distinctive points on the face. These are the point of a nose 106 and the bridge of a nose 107, for example. In addition, eyes 108 and a mouth 109 can be recognized in this way. In a first step of orientation normalization, the ascertained distinctive points are used to compensate for the rotation about a neck by computer. A result is shown schematically in FIG. 2b. It can be seen that the recorded face 101′ normalized with respect to the rotation about the neck is still inclined with respect to the y-axis. In a second orientation normalization step, the face information is transformed such that a connecting line between the tip of the nose 106′ and the bridge of the nose 107′ is oriented parallel to the y-axis 104. The result of this transformation is shown in FIG. 2c. In a further normalization step, the coordinates are adjusted such that a characteristic point on the face coincides with a prescribed point. It is thus possible to achieve a situation in which the tip of the nose 106 is at a prescribed distance perpendicularly from a marked point on a detection plane. The detection plane is, in principle, any desired reference plane, but will normally coincide with a plane in the 3D recording unit.

When the normalization 5 has been performed with the orientation normalization 6 and the position normalization 7, as explained with reference to FIGS. 2a to 2c, a check is performed to determine whether further training faces are to be read in 8. If this is the case, method steps 2 to 7 are carried out again for a further training face. This continues until no further training faces need to be read in. The training faces are then used to stipulate what is known as an evaluation space 9.

FIG. 3a schematically shows a mapping space 120. The mapping space is the space which comprises all those space points at which contour coordinate points for a face can be recorded. It is more or less the recording range of the 3D recording unit. The recorded face information for the training faces, i.e. the training face information data records, is used to ascertain what is known as an evaluation space 121, which is shown by means of dashed lines. The evaluation space is chosen such that it respectively contains the face regions of the face information ascertained by means of the 3D recording unit. The evaluation space is not intended to contain any contour coordinate points which represent other parts of the body or articles, for example, which are not part of the face. If the individual faces were each to be projected into the detection plane, a front surface 122 of the evaluation space 121 is provided by an intersection between the image points contained in the surfaces of the face. A depth of the evaluation space 121, which is indicated by means of an arrow 123, is chosen such that preferably all the z coordinate values are recorded, i.e. all the depth values as viewed from the detection plane, at which contour coordinate points can be found which represent a space point on a contour of one of the training faces.

In the example shown in FIG. 3a, the evaluation space is chosen to be cubic. The front surface may have any desired shape, however. Overall, the evaluation space does not need to be an extrusion body of the front surface, but rather may have any desired shape, provided that the training face data records have no contour coordinate points or just a limited proportion of coordinate points, which are not a point on a contour of one of the training faces, in the evaluation space. To simplify the method for determining the evaluation space and to obtain a sufficiently large evaluation space which actually comprises meaningful face information in the case of training faces which have a very different two-dimensional extent, some embodiments have provision to dispense with the stringent requirement that the evaluation space is not intended to contain any contour coordinate points for a training face information data record which do not represent a point on a contour of one of the training faces. In such a case, an evaluation space is stipulated in which there is a high probability of face information and not information from other articles being recorded. Preferably, it is a requirement that for each training face data record at least a prescribed percentage of the contour coordinate points contained in the evaluation space can be associated with a contour of the respective training face.

Once the evaluation space has been stipulated, a further method step involves evaluation areas in the evaluation space being stipulated 10. Preferably, the evaluation areas comprise a set of subareas or are even congruent with a set of subareas which differ from one another merely in respect of their depth extent with reference to the detection plane.

In the example shown schematically in FIG. 3a, the evaluation space 121 is divided into four evaluation areas 124-127 which each have depth ranges which are of the same magnitude but different. The evaluation areas are in the form of a set of subareas which differ merely in respect of a depth range covered by them with reference to a detection surface (or other reference surface) which coincides with a bounding surface 128 of the mapping space 120, for example. With reference to a coordinate system 102 which comprises an x-axis 103 and a y-axis 104 and also a z-axis 129, the face is respectively oriented as shown in FIG. 2c.

FIGS. 3b and 3c respectively show evaluation areas in different forms. In FIG. 3b, the evaluation areas are likewise in the form of subareas 131-136 in a set of subareas 131-136 which differ from one another merely in respect of the depth range covered by them with reference to a detection plane which coincides with a bounding surface 128 of the mapping space 120. In this case, the evaluation areas or subareas 131-136 are likewise disjunct but comprise depth ranges of different magnitude.

In the embodiment shown in FIG. 3c, the evaluation areas are in the form of two sets of subareas 141-144 and 145-148. In this embodiment, the evaluation areas do not cover the entire evaluation space 121. Other embodiments may have more sets of subareas, for example five sets of subareas, which adjoin one another and each have six disjunct subareas which are formed along the z-axis 129 in each case adjacently to one another and respectively comprise a depth range of the same magnitude. The subareas in the individual sets of subareas have a larger extent along the x-axis than along the y-axis. In this case, an orientation of the face with reference to the coordinate system 102 corresponds to an orientation as shown in FIG. 2c. In this embodiment, a frequency distribution with 30 values is obtained.

Other embodiments are conceivable which have other forms of evaluation areas which respectively comprise mapping space regions.

A stipulation of the evaluation space can, in principle, be left undone. However, this method step provides a simple way of stipulating the evaluation areas by forming the evaluation areas preferably as subareas which differ merely in respect of the depth range covered by them with reference to a reference plane or detection plane. The subareas therefore all have a similar geometric shape, and these shapes differ merely in one dimension as regards their extent and/or position in space. The subareas may be “successive” (for example adjacent cuboids) or “interleaved” (cuboids of different depth, with a common front surface). Preferably, the evaluation areas are stipulated such that the evaluation space is “filled” with the evaluation areas or the entire evaluation space is divided into evaluation areas. This is a particularly simple matter if the evaluation space is an extrusion space which can be expanded along a straight path by means of the extrusion of an extrusion surface. Such an extrusion surface which may be used is that surface which represents an intersection between the face surfaces projected onto the detection plane, for example, as already explained above. Similarly, it is possible to use the surface in which those face surfaces of the individual training faces that are projected onto the detection surface respectively exceed a prescribed surface proportion, as likewise already explained above.

The evaluation areas are used to combine the contour coordinate points of an individual face. This means that it is ascertained for the individual evaluation areas how many contour coordinate points on a face are respectively in an evaluation area. This gives a frequency distribution for the contour coordinate points with reference to the evaluation areas. These frequency distributions are characteristic of individual faces.

The evaluation areas are therefore advantageously stipulated using presets, for example the preset that the entire evaluation space needs to be divided into evaluation areas which represent a set of subareas which respectively differ only in respect of the depth range covered by them with reference to the detection plane. The stipulation is then made using the presets such that the frequency distributions of the individual training faces differ from one another to the maximum extent. This may involve the use of iteration methods.

FIGS. 4a and 4b show two sectional lines 161, 162 through different schematic faces. Both figures respectively show a detection plane 163 which extends perpendicular to the plane of the drawing. The sectional lines 161, 162 show the face contours of two different faces. The face contours are respectively position-normalized for the tip of a nose 164, 165 with reference to the detection plane 163, which is indicated by means of a distance arrow 166. Horizontal lines 167 indicate planes in which a 3D recording unit in the form of a 3D scanner projects lines for recording location information onto the faces shown by means of the sectional lines 161, 162. Points of intersection between the horizontal lines 167 and the sectional lines 161, 162 for the face contours represent respective contour coordinate points 168 in the sectional plane shown. The lines 169 running vertically show boundaries for evaluation areas 170-175 extending perpendicular to the sectional plane. To ascertain a frequency distribution for the contour coordinate points 168 with respect to the evaluation areas 170-175, it is merely necessary to count the contour coordinate points 168 situated in the relevant evaluation area. In this case, it is assumed in the exemplary embodiment shown that the vertical lines 169, which respectively show boundaries for the evaluation areas 170-175, are respectively part of the adjacent one of the evaluation areas 170-175 which is at a greater distance from the detection plane 163. The ascertained frequency distributions 176, 177 are respectively shown in a lower area of FIGS. 4a and 4b as bar charts. Since the same number of contour coordinate points respectively appear in both FIGS. 4a and 4b, the frequency distributions can be used directly as feature data records. If the frequency distributions are shown as feature vectors, a feature vector (2, 1, 10, 4, 4, 3) is obtained for the face shown in FIG. 4a and a feature vector (0, 4, 4, 8, 5, 3) is obtained for the face shown in FIG. 4b.

Normally, it is not possible for the frequency distributions to be compared with one another directly, since, by way of example, a number of the contour coordinate points in the space covered by the evaluation areas is different in the individual training face information. A feature data record is therefore derived from the frequency distributions. By way of example, this is done by normalizing the ascertained frequencies to a total number of the contour coordinate points for a face which are in the evaluation areas.

When the frequency distribution has been calculated and a feature data record has been derived, preferably in the form of a feature vector 11, a test is performed to check whether the evaluation areas have been optimized completely 12. If this is not the case, the evaluation areas are altered 13 and the frequency distributions are calculated and the feature data records for the training faces derived once more 11. If the evaluation areas have been optimized completely, information describing in the evaluation areas is stored 17 and then a test is performed to determine whether the training faces need to be recognized later 14. This is usually the case, which means that the feature data records and any recorded identification information are then stored in a data store in the form of a database 15. The training mode of the method 1 is then complete 16.

If the result of the test 2 is that the method is not intended to be operated in the training mode, face information for a face is recorded using the 3D recording unit 3′. The recorded face information is then normalized 5′, which comprises orientation normalization 6′ and position normalization 7′. The method steps for the normalization 5′ to 7′ are the same as the normalization steps 5 to 7 which have been explained above. The frequency distribution of the contour coordinate points is then calculated with reference to the evaluation areas stipulated in the training mode, and a feature data record is derived therefrom 11′. This may involve resorting to the stored information relating to the evaluation areas.

A test is used to establish whether the method is intended to recognize a face or whether the face is to be added to the set of faces to be recognized 19. If the face is to be added, i.e. the method is operated in an addition mode, identification information is then advantageously recorded for the face 4′. Next, the feature data record is stored together with the possibly recorded identification information in the memory area in the database 15′. The end of the method in the addition mode has then been reached 20.

At this juncture, it will again be pointed out that it is not necessary to resort to the data for the training faces in order to add a further face to the set of faces to be recognized. A further face can be added or else a face or a plurality of faces can be deleted without this requiring increased computation complexity. In addition, it is not necessary to store all the recorded contour coordinate points, i.e. the entire face information data record, from the face to be recognized, but rather only a significantly reduced feature data record. This results in a considerable reduction in the memory space required for storage. Particularly with large groups of people whose faces need to be recognized, this is of enormous advantage.

If the method is intended to be operated not in the addition mode but rather in the recognition mode, a previously known feature data record is read in from the database, 21, after ascertainment of the feature data record 11′ and the relevant test 19. The feature data record is then compared with the previously known feature data record 22. This involves ascertainment of a similarity between the feature data record and the previously known feature data record. The feature data record and the previously known feature data record are usually in the form of feature vectors. A person skilled in the art knows of methods allowing the similarity of feature data records or feature vectors to be ascertained. This may involve one or more test criteria being taken into account in order to establish the similarity between a feature vector and a previously known feature vector. To determine the similarity, it is possible to use what is known as a city block method, for example, or to evaluate a euclidian distance or correlation, to mention but a few methods by way of example. A test is used to test whether the feature data record (feature vector) is similar to the previously known feature data record (previously known feature vector) 23. If this is not the case, a check is then performed to determine whether the database stores further previously known feature data records (previously known feature vectors) which have not yet been compared with the feature data record 24. If there are such previously known feature data records, these are read in 21 and compared with the feature data vector 22.

If it is established in the test 23 that the feature data record matches a previously known feature data record, the face from whose face information data record the feature data record has been ascertained is deemed to be recognized as the previously known face from whose face information data record the previously known feature data record used to establish a match was originally ascertained. This result is output 25, possibly with identification information for the previously known feature data record. If a match is not found 23 and if, additionally, the test for whether there are further previously known data records stored in the database which have not been compared with the feature data record 24 can be answered in the negative, the face was not able to be recognized as one of the previously known faces, and this is likewise output 26. The method is complete in the recognition mode 27.

FIG. 5 schematically shows an apparatus 180 for recognizing a face 181. The face 181 is arranged in front of a 3D recording unit 182. The 3D recording unit 182 records face information for the face 181 in the form of a face information data record. This data record is transmitted to a normalization unit 183. In some embodiments, the normalization unit 183 may be part of the 3D recording unit 182. In other embodiments, such as the one shown here, the normalization unit 183 is part of a recognition unit 184. When the face information has been normalized using the normalization unit 183, it is evaluated by an evaluation unit 185. This involves the ascertainment of a frequency distribution for contour coordinate points for the recorded face with respect to evaluation areas. The frequency distribution is used to derive a feature data record which is compared with previously known feature data records in a comparison unit 186. The previously known feature data records required for this purpose can be read in from a data store 187 in which a database 188 manages the previously known feature data records. If a match is found between the feature data record for the recorded face 181 and one of the previously known feature data records, the face 181 is deemed to have been recognized as the face from whose face information data record the relevant previously known feature data record was once derived. A piece of information relating to this and possibly identification information stored for the previously known feature data record in the database 188 are output via an output unit 189.

The apparatus 180 is in a form such that it can be used for ascertaining a new previously known feature data record. For this purpose, the apparatus 181 has an input unit 190 which can be used to put the apparatus 180 into an addition mode. In addition, the input unit can be used to input identification information about the person or the face, from whose face information a new previously known feature data record is derived and is then stored together with this information in the database 188. The evaluation unit 185 may also be in a form such that an evaluation range and the evaluation areas can be stipulated in a training mode. To this end, the apparatus 180 is able to record training face information data records for a plurality of training faces and to ascertain an evaluation space and evaluation areas therefrom, as described above, and possibly to store the ascertained feature data records for the training faces in the database 188 of the data store 187. As indicated by a dashed line 191, the recognition unit 184 may also be in a form without the data store 187 and the database 188. In this case, the storage takes place on an external data store 187, which does not necessarily need to contain a database 188. The external data store 187 may also be a smart card or a similar portable data store on which only a previously known feature data record is stored. The effect achieved by this is that the person-related feature data are stored only on a data store of the person from whose face they have been derived.

In yet another embodiment, the recognition unit 184 also does not comprise the comparison unit 186. As indicated by means of a dotted line 192, the comparison unit 186 is produced with the data store 187 in a portable unit, the data store 187 likewise not needing to comprise a database 188. Thus, the comparison step can also be performed in the portable unit, which has the dotted line 192 around its edge. In this embodiment, the feature data do not need to be read from the portable unit and are also not made accessible to the recognition unit 184. Such portable units are also referred to as “on card matchers”.

FIG. 6 schematically shows a face recognition module. A face recognition module is preferably in the form of a computer-executable code which can be executed on a computer. The face recognition module 200 comprises an interface 201 which can be used to receive or read in or record face information data records. The face information data records may already be normalized. It is likewise possible for the face recognition module 200 to comprise a normalization unit 202. The normalized face information data records are processed further in an evaluation unit 203. This involves ascertaining a frequency distribution for the contour coordinate points for evaluation areas. The frequency distribution is used to derive a feature data record. If the face recognition module is being operated in an addition mode, the feature data record is output via a further interface 204 and can be stored in a database 205. An additional interface 207 can be used to read in previously known feature data records from the database 205, which are compared with the feature data record in a comparison unit 208 when the face recognition module 200 is being operated in a recognition mode. If there is a degree of similarity between the feature data record and one of the previously known feature data records, the face is deemed to have been recognized. A piece of information about this can be output via the further interface 204. The interface 201, the further interface 204 and the additional interface 207 may be produced in pairs or jointly in a single interface. The evaluation unit 203 of the face recognition module 200 is preferably in a form such that it is able to use a plurality of training face information data records which are received via the interface 201 to ascertain an evaluation space and evaluation areas in a training mode, as explained above.

The preferred methods described and the corresponding apparatus or the corresponding face recognition module each have provision for a training mode to be able to be used in order to stipulate the evaluation areas. In another embodiment, provision may be made for the evaluation areas to be stipulated in advance and not to be ascertained only in a training mode.

### LIST OF REFERENCE SYMBOLS

1 Method for recognizing a face
2 Training mode test
3 Recording of 3D face information
4 Recording of identification information
5, 5′ Normalization of the face information
6, 6′ Position normalization
7, 7′ Orientation normalization
8 Read in further training faces?
9 Evaluation space stipulation
10 Determination of the evaluation areas
11, 11′ Calculation of the frequency distribution and derivation of a feature data record
12 Optimization of the evaluation areas complete?
13 Alteration of the evaluation areas
14 Test: are training faces intended to be recognized later?
15, 15′ Storage in a particular memory in the form of a database
16 End of training mode
17 Storage of information about the evaluation areas
19 Test: addition mode or recognition mode?
20 End of addition mode
21 Read in previously known feature data record
22 Compare feature data record with previously known feature data record
23 Test: is there a similarity (recognition)?
24 Test: are there further previously known feature data records?
25 Output face recognized
26 Output face not recognized
27 End of recognition mode
101, 101′, 101″ Recorded face
102 Coordinate system
103 x-axis
104 y-axis
105 Cross as representation of the z-axis
106, 106′, 106″ Tip of the nose
107, 107′, 107″ Bridge of the nose
108, 108′, 108″ Eyes
109, 109′, 109″ Mouth
120 Mapping space
121 Evaluation space
122 Front surfaces of the evaluation space
123 Arrow
124-127 Evaluation areas
128 Base surface of the mapping space
129 z-axis
131-136 Subareas
141-144 Subareas
145-148 Subareas
161, 162 Sectional lines for face contours
163 Detection plane
164, 165 Tip of the nose
166 Distance arrow
167 Horizontal lines
168 Contour coordinate points
169 Vertical lines
170-175 Evaluation areas
176, 177 Frequency distributions in the form of bar charts
180 Apparatus for face recognition
181 Face
182 3D recording unit
183 Normalization unit
184 Recognition unit
185 Evaluation unit
186 Comparison unit
187 Data store
188 Database
189 Output unit
190 Input unit
191 Dashed line
192 Dotted line
200 Face recognition module
201 Interface
202 Normalization unit
203 Evaluation unit
204 Further interface
205 Database
207 Additional interface
208 Comparison unit

1-30. (canceled)

31. A method for recognizing a face, comprising:
using a 3D recording unit to obtain recorded face information by recording three-dimensional face information of the face, wherein the recorded face information includes location information relating to surface contours of the face, wherein the recorded face information forms a face information data record, and wherein the location information includes contour coordinate points;
obtaining normalized recorded face information by normalizing the recorded face information with respect to position and by normalizing the recorded face information with respect to orientation;
defining evaluation areas and determining a frequency distribution indicating how many contour coordinate points are in the evaluation areas;
using the normalized recorded face information and the frequency distribution to derive a feature data record; and
using a comparison unit to compare the feature data record with at least one previously known feature data record for a previously known face, and recognizing the face as the previously known face if one or more prescribed comparison criteria are met.

32. The method according to claim 31, wherein the step of defining evaluation areas includes defining the evaluation areas with at least one set of subareas that differ from one another only with respect to a depth range covered by the subareas.

33. The method according to claim 32, wherein the subareas are disjunct.

34. The method according to claim 31, wherein the step of defining evaluation areas includes defining the evaluation areas in an evaluation space that includes only a subregion of a mapping space that may contain recorded contour coordinate points depending on the frequency distribution.

35. The method according to claim 31, which comprises:
recording training face information data records for a set of training faces;
normalizing face information contained in the training face information data records; and
stipulating an evaluation space using the training face information data records such that the evaluation space contains only contour coordinate points that are associated with the training faces or such that, for each of the training face information data records, the evaluation space contains at least a stipulated percentage of contour coordinate points that are associated with a relevant training face.

36. The method according to claim 31, wherein the step of defining the evaluation areas is performed such that feature data records for individual training faces differ from one another to a maximum extent.

37. The method according to claim 31, which comprises obtaining the previously known feature data record by:
using the 3D recording unit to obtain additional recorded face information by recording three-dimensional face information of the previously known face, wherein the additional recorded face information includes location information relating to surface contours of the previously known face, wherein the additional recorded face information forms a face information data record, and wherein the location information includes contour coordinate points;
obtaining additional normalized recorded face information by normalizing the additional recorded face information with respect to position and by normalizing the additional recorded face information with respect to orientation;
determining an additional frequency distribution indicating how many contour coordinate points are in the evaluation areas;
using the additional normalized recorded face information and the additional frequency distribution to derive the previously known feature data record; and
storing the previously known feature data record.

38. The method according to claim 31, which comprises: storing the at least one previously known feature data record with identification information for the previously known face in a database.

39. The method according to claim 31, which comprises: choosing a set of training faces as a genuine subset of a plurality of faces to be recognized or disjunctly from the plurality of faces to be recognized.

40. The method according to claim 31, which comprises: storing feature data records for training faces as previously known feature data records.

41. An apparatus for recognizing a face, comprising:
a recording unit configured to obtain recorded face information by recording three-dimensional face information of a face, wherein the recorded face information includes location information relating to surface contours of the face, wherein the recorded face information forms a face information data record, and wherein the location information includes contour coordinate points;
a normalization unit configured to obtain normalized recorded face information by normalizing the recorded face information with respect to position and by normalizing the recorded face information with respect to orientation;
a comparison unit configured to compare a feature data record, which is derived from the normalized recorded face information, with at least one previously known feature data record for a previously known face, wherein the face is recognized as the previously known face if one or more prescribed comparison criteria are met; and
an evaluation unit configured to determine a frequency distribution indicating how many contour coordinate points are in individual evaluation areas;
said evaluation unit configured to derive the feature data record from frequencies ascertained from the frequency distribution.

42. The apparatus according to claim 41, wherein the evaluation areas include at least one set of subareas that differ from one another only with respect to a depth range covered by the subareas.

43. The apparatus according to claim 41, wherein the evaluation areas are in an evaluation space that includes only a subregion of a mapping space that may contain recorded contour coordinate points.

44. The apparatus according to claim 43, wherein the subareas are disjunct.

45. The apparatus according to claim 41, wherein:
training face information data records are recorded for a set of training faces;
the training face information data records includes face information that is normalized; and
the evaluation unit is configured to stipulate an evaluation space using the training face information data records such that the evaluation space contains only contour coordinate points that are associated with the training faces or such that, for each of the training face information data records, the evaluation space contains at least a stipulated percentage of contour coordinate points that are associated with a relevant training face.

46. The apparatus according to claim 41, wherein the evaluation unit is configured to stipulate evaluation areas such that feature data records for the training faces differ from one another to a maximum extent.

47. The apparatus according to claim 41, in combination with a data storage device for storing the at least one previously known feature data record, wherein the at least one previously known feature data record is ascertained using the apparatus, and wherein the apparatus is operable in an operating mode in which the comparison unit does not compare the feature data record.

48. The apparatus according to claim 47, wherein the data storage device stores a database, and the at least one previously known feature data record is stored with identification information for the previously known face in the database.

49. The apparatus according to claim 41, wherein a set of training faces is chosen as a genuine subset of a plurality of faces to be recognized or disjunctly from the plurality of faces to be recognized.

50. The apparatus according to claim 41, comprising a data storage device storing feature data records for training faces as previously known feature data records.

51. A face recognition module for recognizing a face, the face recognition module comprising:
an interface configured to receive recorded three-dimensional face information of a face, wherein the recorded face information includes location information relating to surface contours of the face, wherein the recorded face information forms a face information data record, and wherein the location information includes contour coordinate points;
a normalization unit configured to obtain normalized recorded face information by normalizing the recorded face information with respect to position and by normalizing the recorded face information with respect to orientation;
a comparison unit configured to compare a feature data record, which is derived from the normalized recorded face information, with at least one previously known feature data record for a previously known face, wherein the face is recognized as the previously known face if one or more prescribed comparison criteria are met; and
an evaluation unit configured to determine a frequency distribution indicating how many contour coordinate points are in individual evaluation areas;
said evaluation unit configured to derive the feature data record from frequencies ascertained from the frequency distribution.

52. The face recognition module according to claim 51, wherein the evaluation areas include at least one set of subareas that differ from one another only with respect to a depth range covered by the subareas.

53. The face recognition module according to claim 51, wherein the evaluation areas are in an evaluation space that includes only a subregion of a mapping space that may contain recorded contour coordinate points.

54. The face recognition module according to claim 53, wherein the subareas are disjunct.

55. The face recognition module according to claim 51, wherein:
the interface is configured to receive training face information data records for a set of training faces; and
the evaluation unit is configured to stipulate an evaluation space using the training face information data records such that the evaluation space contains only contour coordinate points that are associated with the training faces or such that, for each of the training face information data records, the evaluation space contains at least a stipulated percentage of contour coordinate points that are associated with a relevant training face.

56. The face recognition module according to claim 55, wherein the evaluation unit is configured to stipulate evaluation areas such that feature data records for the training faces differ from one another to a maximum extent.

57. The face recognition module according to claim 51, wherein the interface outputs at least one data record selected from the group consisting of the feature data record, which was derived from the normalized recorded face information, and derived feature data records for training face data records.

58. The face recognition module according to claim 51, further comprising a further interface outputting at least one data record selected from the group consisting of the feature data record, which was derived from the normalized recorded face information, and derived feature data records for training face data records.

59. The face recognition module according to claim 51, wherein the interface is configured to read in at least one item, which is selected from the group consisting of the at least one feature data record and identification information, from a database.

60. The face recognition module according to claim 51, further comprising an interface configured to read in at least one item, which is selected from the group consisting of the at least one feature data record and identification information, from a database.
